(19) United States
(12) Patent Application Publication
(10) Pub. No.: US 2017/0372663 A1
(43) Pub. Date: Dec. 28, 2017

(54) Pixel Compensation Circuit, Method And Flat Display Device

(71) Applicant: Shenzhen China Star Optoelectronics Technology Co., Ltd., Shenzhen, Guangdong (CN)

(72) Inventor: Xiaoling WU, Shenzhen, Guangdong (CN)

(73) Assignee: Shenzhen China Star Optoelectronics Technology Co., Ltd., Shenzhen, Guangdong (CN)

(21) Appl. No.: 15/023,381

(22) PCT Filed: Feb. 25, 2016
(86) PCT No.: PCT/CN2016/074552

§ 371 Date: Mar. 19, 2016

(30) Foreign Application Priority Data
Jan. 29, 2016 (CN) 201610069689.2

(51) Int. Cl. G09G 3/3291; G09G 3/3233; G09G 3/3258; G09G 3/3266

(52) U.S. Cl. CPC G09G 3/3291; G09G 3/3266; G09G 3/3233; G09G 3/3258; G09G 2300/043

(57) ABSTRACT

Pixel compensation circuit, method and flat display device. The circuit includes control terminals of first to fourth controllable and driving switches respectively connected with first to fourth scanning lines and second terminal of the second controllable switch, first terminal of the first controllable switch connected with data line; first terminal of the second controllable switch connected with second terminal of the first controllable switch; first terminal of the third controllable switch connected with the second terminal of the first controllable switch; the second terminal of the first controllable switch is connected with the second terminal of the driving switch through a storage capacitor; anode of an OLED connected with the second terminal of the driving switch, cathode is grounded; first terminal of the fourth controllable switch connected with second voltage terminal, which can avoid unstable current of the organic light emitting diode by drift of threshold voltage of driving transistor.

### BACKGROUND OF THE INVENTION

### 1. Field of the Invention

The present invention relates to a display technology field, and more particularly to a pixel compensation circuit, a method and a flat display device.

### 2. Description of Related Art

A current Organic Light Emitting diode (OLED) display has advantages of small size, simple structure, self-lighting, high brightness, wide viewing-angle, short response time, and so on, attracting widespread attention.

In the current organic light emitting diode display, a transistor is used as a driving transistor for controlling a current flowing through an organic light emitting diode OLED so that the importance of a threshold voltage of the driving transistor is very obvious. A positive drift or a negative drift of the threshold voltage will make different currents flowing through the organic light emitting diode under a same data signal. In a usage process of the transistor, factors of lighting in the oxide semiconductor or voltage stress of source and drain electrode may cause the threshold voltage to drift such that the current of the organic light emitting diode is unstable, and the display brightness of a panel is uneven.

### SUMMARY OF THE INVENTION

The main technology problem solved by the present invention is to provide a pixel compensation circuit, a method and a flat display device in order to avoid an unstable current of the organic light emitting diode caused by the drift of the threshold voltage of the driving transistor to realize an even brightness display of the pane

In order to solve the above technology problem, a technology solution provided by the present invention is: a pixel compensation circuit, comprising:

a first controllable switch, wherein the first controllable switch includes a control terminal, a first terminal and a second terminal; the control terminal of the first controllable switch is connected with a first scanning line, a first terminal of the first controllable switch is connected with a data line in order to receive a data voltage from the data line;

a second controllable switch, wherein the second controllable switch includes a control terminal, a first terminal and a second terminal; the control terminal of the second controllable switch is connected with a second scanning line the first terminal of the second controllable switch is connected with the second terminal of the first controllable switch;

a driving switch, wherein the driving switch includes a control terminal, a first terminal and a second terminal; the control terminal of the driving switch is connected with the second terminal of the second controllable switch, the first terminal of the driving switch is connected with a first voltage terminal in order to receive a first voltage from the first voltage terminal;

a third controllable switch, wherein the third controllable switch includes a control terminal, a first terminal and a second terminal; the control terminal of the third controllable switch is connected with a third scanning line; the first terminal of the third controllable switch is connected with the second terminal of the first controllable switch and the first terminal of the second controllable switch, the second terminal of the third controllable switch is connected with the first terminal of the driving switch;

a storage capacitor, wherein the storage capacitor includes a first terminal and a second terminal; the first terminal of the storage capacitor is connected with the second terminal of the first controllable switch, and the second terminal of the storage capacitor is connected with the second terminal of the driving switch;

an organic light emitting diode, wherein the organic light emitting diode includes an anode and a cathode; the anode of the organic light emitting diode is connected with the second terminal of the driving switch, and the cathode of the organic light emitting diode is connected with a ground; and

a fourth controllable switch, wherein the fourth controllable switch includes a control terminal, a first terminal and a second terminal; the control terminal of the fourth controllable switch is connected with a fourth scanning line, the first terminal of the fourth controllable switch is connected with a second voltage terminal in order to receive a second voltage from the second voltage terminal, and the second terminal of the fourth controllable switch is connected with the second terminal of the driving switch.

Wherein, the driving switch, the first controllable switch to the fourth controllable switch are all NMOS thin-film transistors, PMOS thin-film transistors or a combination of NMOS thin-film transistors and PMOS thin-film transistors; the control terminal, the first terminal and the second terminal of each of the driving switch, the first controllable switch to the fourth controllable switch are respectively corresponding to a gate electrode, a drain electrode and a source electrode of the thin-film transistor.

In order to solve above technology problem, another technology solution provided by the present invention is: a pixel compensation method, comprising:

in a reset stage, a driving switch and a fourth controllable switch are turned on, a first to a third controllable switches are turned off, a voltage Vb at a second terminal of the driving switch is equal to a second voltage VL outputted from a second voltage terminal; because of a coupling function of a storage capacitor, a voltage Va at a first terminal of the storage capacitor is decreased so as to remove an affection of a data of a previous frame;

in a threshold voltage obtaining stage, the driving switch, the second controllable switch and the third controllable switch are both turned on, the first controllable switch and the fourth controllable switch are both turned off, the storage capacitor is charged; the voltage Vb at the second terminal of the driving switch is equal to a difference value between a first voltage VDD outputted from a first voltage terminal and a threshold voltage Vth of the driving switch, the voltage Va of the first terminal of the storage capacitor is equal to the first voltage VDD;

in a data writing stage, the driving switch and the first controllable switch are both turned on, the second to the fourth switches are turned off, and the storage capacitor is charged; the voltage Va at the first terminal of the storage capacitor is equal to a data voltage Vdata outputted from a data line; the voltage Vb at the second terminal of the driving switch, Vb=VDD−Vth+ΔV, wherein, VDD is the first voltage, Vth is the threshold voltage of the driving switch, ΔV is a voltage increment at the second terminal of the driving switch; and

in a driving emitting stage, the driving switch and the second controllable switch are both turned on, the first controllable switch, the third controllable switch and the fourth controllable switch are all turned off; the storage capacitor is discharged, a voltage difference Vgs between the control terminal and the second terminal of the driving switch is equal to a voltage difference between two terminals of the storage capacitor, that is, Vgs=Vdata−VDD+Vth−ΔV, a current I flowing through the organic light emitting diode is that I=K*(Vgs−Vth)2=K*(Vdata−VDD−ΔV)2, wherein K is a coefficient.

Wherein, the driving switch, the first controllable switch to the fourth controllable switch are all NMOS thin-film transistors, PMOS thin-film transistors or a combination of NMOS thin-film transistors and PMOS thin-film transistors; the control terminal, the first terminal and the second terminal of each of the driving switch, the first controllable switch to the fourth controllable switch are respectively corresponding to a gate electrode, a drain electrode and a source electrode of the thin-film transistor.

In order to solve above technology problem, another technology solution provided by the present invention is: a flat display device, wherein, the flat display device includes a pixel compensation circuit, and the pixel compensation circuit comprises:

a first controllable switch, wherein the first controllable switch includes a control terminal, a first terminal and a second terminal; the control terminal of the first controllable switch is connected with a first scanning line, a first terminal of the first controllable switch is connected with a data line in order to receive a data voltage from the data line;

a second controllable switch, wherein the second controllable switch includes a control terminal, a first terminal and a second terminal; the control terminal of the second controllable switch is connected with a second scanning line the first terminal of the second controllable switch is connected with the second terminal of the first controllable switch;

a driving switch, wherein the driving switch includes a control terminal, a first terminal and a second terminal; the control terminal of the driving switch is connected with the second terminal of the second controllable switch, the first terminal of the driving switch is connected with a first voltage terminal in order to receive a first voltage from the first voltage terminal;

a third controllable switch, wherein the third controllable switch includes a control terminal, a first terminal and a second terminal; the control terminal of the third controllable switch is connected with a third scanning line; the first terminal of the third controllable switch is connected with the second terminal of the first controllable switch and the first terminal of the second controllable switch, the second terminal of the third controllable switch is connected with the first terminal of the driving switch;

a storage capacitor, wherein the storage capacitor includes a first terminal and a second terminal; the first terminal of the storage capacitor is connected with the second terminal of the first controllable switch, and the second terminal of the storage capacitor is connected with the second terminal of the driving switch;

an organic light emitting diode, wherein the organic light emitting diode includes an anode and a cathode; the anode of the organic light emitting diode is connected with the second terminal of the driving switch, and the cathode of the organic light emitting diode is connected with a ground; and

a fourth controllable switch, wherein the fourth controllable switch includes a control terminal, a first terminal and a second terminal; the control terminal of the fourth controllable switch is connected with a fourth scanning line, the first terminal of the fourth controllable switch is connected with a second voltage terminal in order to receive a second voltage from the second voltage terminal, and the second terminal of the fourth controllable switch is connected with the second terminal of the driving switch.

Wherein, the driving switch, the first controllable switch to the fourth controllable switch are all NMOS thin-film transistors, PMOS thin-film transistors or a combination of NMOS thin-film transistors and PMOS thin-film transistors; the control terminal, the first terminal and the second terminal of each of the driving switch, the first controllable switch to the fourth controllable switch are respectively corresponding to a gate electrode, a drain electrode and a source electrode of the thin-film transistor.

Wherein the flat display device is an OLED or an LCD.

The beneficial effects of the present invention are: comparing with the prior art, the pixel compensation circuit and method of the present invention, through using multiple thin-film transistors as a driving transistor in order to avoid an unstable current of the organic light emitting diode caused by the drift of the threshold voltage of the driving transistor to realize an even brightness display of the panel.

### BRIEF DESCRIPTION OF THE DRAWINGS

FIG. 1 is a schematic diagram of a pixel compensation circuit of the present invention;

FIG. 2 is a waveform diagram of the pixel compensation circuit of the present invention;

FIG. 3 is a simulation result diagram of the pixel compensation circuit of the present invention;

FIG. 4 is a schematic diagram of a scanning driving circuit of the present invention; and

FIG. 5 is a schematic diagram of a flat display device of the present invention.

### DETAILED DESCRIPTION OF THE PREFERRED EMBODIMENT

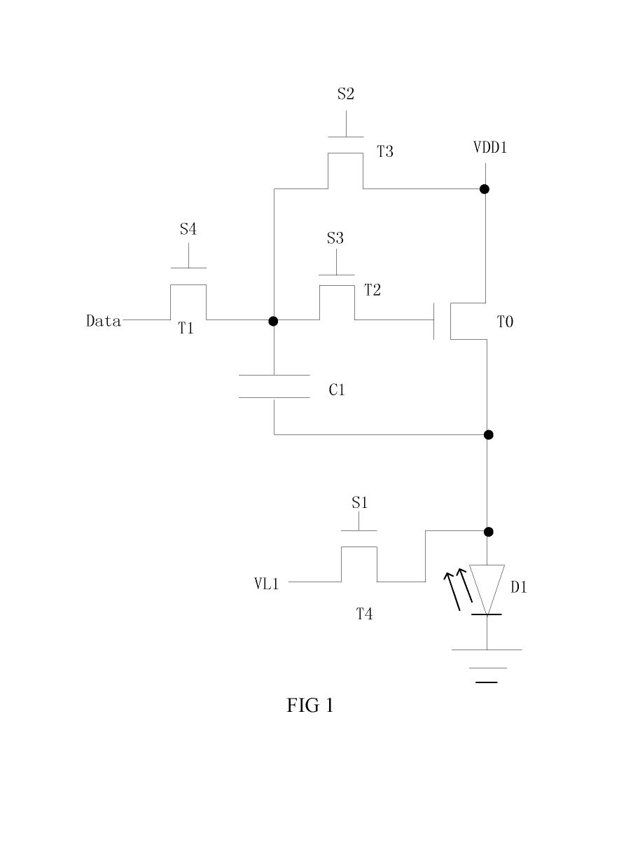

With reference to FIG. 1, and FIG. 1 is a schematic diagram of a pixel compensation circuit of the present invention. As shown in FIG. 1, the pixel compensation circuit includes a first controllable switch T1. The first controllable switch T1 includes a control terminal, a first terminal and a second terminal. The control terminal of the first controllable switch T1 is connected with a first scanning line S4, a first terminal of the first controllable switch T1 is connected with a data line Data in order to receive a data voltage Vdata from the data line Data.

A second controllable switch T2, the second controllable switch T2 includes a control terminal, a first terminal and a second terminal. The control terminal of the second controllable switch T2 is connected with a second scanning line S3, the first terminal of the second controllable switch T2 is connected with the second terminal of the first controllable switch T1;

A driving switch T0, the driving switch T0 includes a control terminal, a first terminal and a second terminal. The control terminal of the driving switch T0 is connected with the second terminal of the second controllable switch T2, the first terminal of the driving switch T0 is connected with a first voltage terminal VDD1 in order to receive a first voltage VDD from the first voltage terminal VDD1.

A third controllable switch T3, the third controllable switch T3 includes a control terminal, a first terminal and a second terminal. The control terminal of the third controllable switch T3 is connected with a third scanning line S2. The first terminal of the third controllable switch T3 is connected with the second terminal of the first controllable switch T1 and the first terminal of the second controllable switch T2. The second terminal of the third controllable switch T3 is connected with the first terminal of the driving switch T0.

A storage capacitor C1, the storage capacitor C1 includes a first terminal and a second terminal. The first terminal of the storage capacitor C1 is connected with the second terminal of the first controllable switch T1, and the second terminal of the storage capacitor C1 is connected with the second terminal of the driving switch T0;

An organic light emitting diode D1, the organic light emitting diode D1 includes an anode and a cathode. The anode of the organic light emitting diode D1 is connected with the second terminal of the driving switch T0, and the cathode of the organic light emitting diode D1 is connected with a ground.

A fourth controllable switch T4, the fourth controllable switch T4 includes a control terminal, a first terminal and a second terminal. The control terminal of the fourth controllable switch T4 is connected with a fourth scanning line S1, the first terminal of the fourth controllable switch T4 is connected with a second voltage terminal VL1 in order to receive a second voltage VL from the second voltage terminal VL1, and the second terminal of the fourth controllable switch T4 is connected with the second terminal of the driving switch T0.

In the present embodiment, the driving switch T0, the first controllable switch T1 to the fourth controllable switch T4 are all NMOS thin-film transistors, PMOS thin-film transistors or a combination of NMOS thin-film transistors and PMOS thin-film transistors. The control terminal, the first terminal and the second terminal of each of the driving switch T0, the first controllable switch T1 to the fourth controllable switch T4 are respectively corresponding to a gate electrode, a drain electrode and a source electrode of the thin-film transistor.

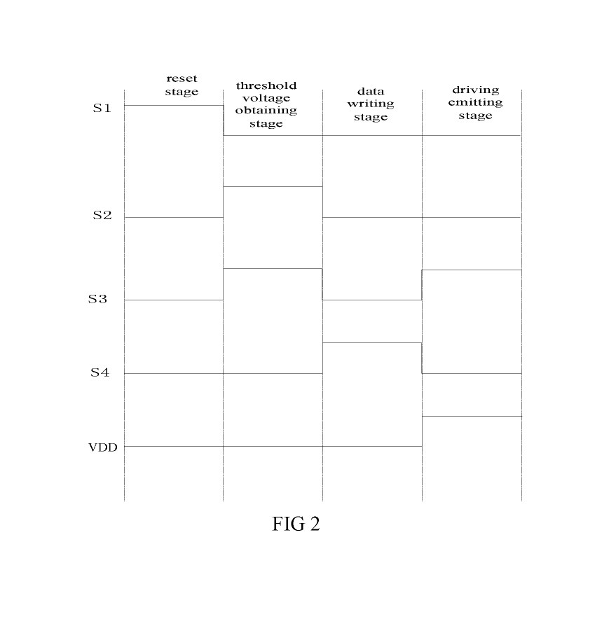

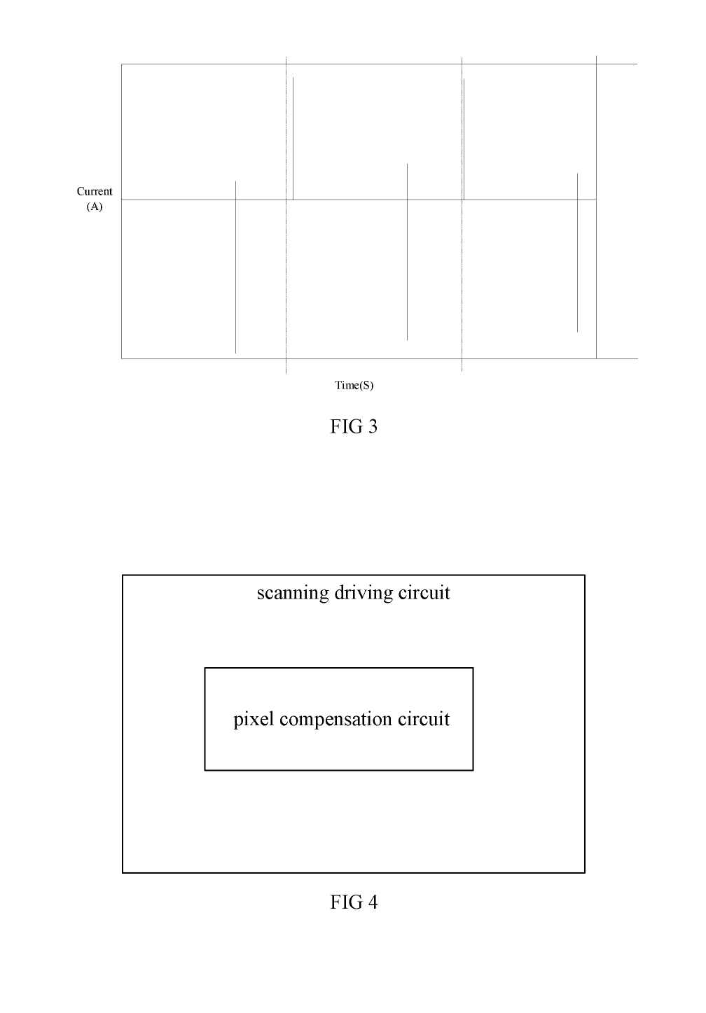

With reference to FIG. 2, and FIG. 2 is a waveform diagram of the pixel compensation circuit of the present invention. FIG. 3 is a simulation result diagram of the pixel compensation circuit of the present invention. According to FIG. 1 to FIG. 3, the operation principle (the pixel compensation method) of the pixel compensation circuit obtained from FIG. 1 to FIG. 3 is as following:

In a reset stage, a driving switch T0 and a fourth controllable switch T4 are turned on, a first to a third controllable switches T1-T3 are turned off. A voltage Vb at a second terminal of the driving switch T0 is equal to a second voltage VL outputted from a second voltage terminal VL1. Because of a coupling function of a storage capacitor C1, a voltage Va at a first terminal of the storage capacitor C1 is decreased so as to remove an affection of a data of a previous frame;

In a threshold voltage obtaining stage, the driving switch T0, the second controllable switch T2 and the third controllable switch T3 are both turned on. The first controllable switch T1 and the fourth controllable switch T4 are both turned off. The storage capacitor C1 is charged.

The voltage Vb at the second terminal of the driving switch T0 is equal to a difference value between a first voltage VDD outputted from a first voltage terminal VDD1 and a threshold voltage Vth of the driving switch T0. The voltage Va of the first terminal of the storage capacitor C1 is equal to the first voltage VDD.

In a data writing stage, the driving switch T0 and the first controllable switch T1 are both turned on, the second to the fourth switches T2-T4 are turned off, and the storage capacitor C1 is charged. The voltage Va at the first terminal of the storage capacitor C1 is equal to a data voltage Vdata outputted from a data line Data. The voltage Vb at the second terminal of the driving switch T0 satisfies a following relationship:

Vb=VDD−Vth+ΔV (formula 1)

wherein, VDD is the first voltage, Vth is the threshold voltage of the driving switch T0, ΔV is a voltage increment at the second terminal of the driving switch T0. The voltage increment is generated because a variation of the voltage Va (the variation value is Vdata−VDD) at the first terminal of the storage capacitor C1, through a coupling action of capacitors (including the storage capacitor C1, a capacitor of the light emitting diode D1, parasitic capacitors of the second controllable switch T2 and the driving switch T0) so that the voltage Vb at the second terminal of the driving switch T0 is also varied (the variation value is ΔV).

In a driving emitting stage, the driving switch T0 and the second controllable switch T2 are both turned on, the first controllable switch T1, the third controllable switch T3 and the fourth controllable switch T4 are all turned off. The storage capacitor C1 is discharged, a voltage difference Vgs between the control terminal and the second terminal of the driving switch T0 is equal to a voltage difference between two terminals of the storage capacitor C1, and that is, Vgs satisfy a following relationship:

Vgs=Vdata−VDD+Vth−ΔV (formula 2);

a current I flowing through the organic light emitting diode D1 satisfy a flowing relationship:

I=K*(Vgs−Vth)²=K*(Vdata−VDD−ΔV)² (formula 3);

wherein, K is a coefficient and satisfies a following relationship:

K=μCoxW/(2*L) (formula 4);

Wherein, μ is electron mobility, Cox is a capacitance of an insulation layer of a thin-film transistor of a unit area; L and W are respectively an effective channel and channel width length of the driving switch T0.

From the above formula 3 and formula 4 and combined with table 1 shown below, a current flowing through the organic light emitting diode D1 is unrelated to the threshold voltage Vth of the driving switch T0.

TABLE 1

| | Vto = 1.2 V | Vto = 1.7 V | % | Vto = 0.7 V | % |
|---|---|---|---|---|---|
| Vdata | I_{OLED} | I_{OLED} | ΔI_{OLED} | I_{OLED} | ΔI_{OLED} |
| V1 | 5.78E−08 | 5.58E−08 | 3.42% | 5.58E−08 | 3.45% |
| V2 | 5.51E−07 | 5.53E−07 | 0.25% | 5.70E−07 | 3.30% |
| V3 | 1.10E−06 | 1.08E−06 | 1.51% | 1.11E−06 | 1.20% |

Therefore, the pixel compensation circuit can avoid an unstable current of the light emitting diode caused by the drift of the threshold voltage Vth of the driving switch T0 in order to realize an even brightness display of the panel.

With reference to FIG. 4, and FIG. 4 is a schematic diagram of scanning driving circuit of the present invention. The scanning driving circuit includes a pixel compensation circuit to avoid an uneven brightness display of the panel generated by the drifting of the threshold voltage of the driving transistor in the scanning driving circuit.

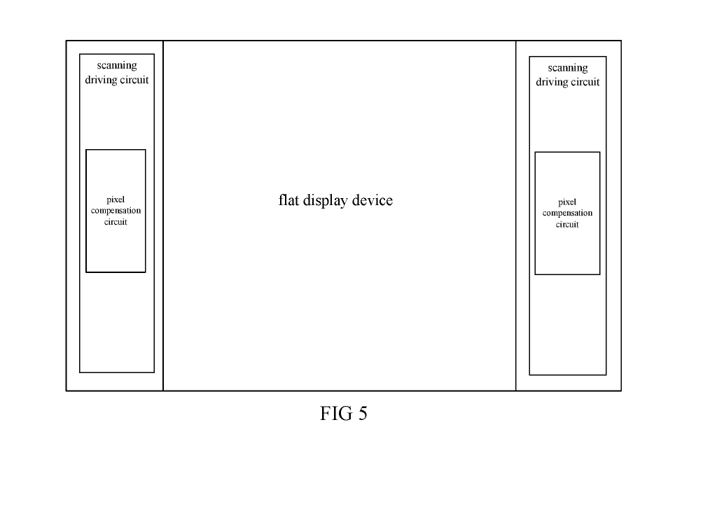

FIG. 5 is a schematic diagram of a flat display device of the present invention. The flat display device can be an OLED or an LCD. The flat display device includes the above scanning driving circuit and the pixel compensation circuit. The scanning driving circuit of the pixel compensation circuit is disposed at the periphery of the flat display device such as disposing at two terminals of the flat display device.

The pixel compensation circuit and method, through using multiple thin-film transistors as a driving transistor in order to avoid an unstable current of the organic light emitting diode caused by the drift of the threshold voltage of the driving transistor to realize an even brightness display of the panel.

The above embodiments of the present invention are not used to limit the claims of this invention. Any use of the content in the specification or in the drawings of the present invention which produces equivalent structures or equivalent processes, or directly or indirectly used in other related technical fields is still covered by the claims in the present invention.

What is claimed is:

1. A pixel compensation circuit, comprising:
a first controllable switch, wherein the first controllable switch includes a control terminal, a first terminal and a second terminal; the control terminal of the first controllable switch is connected with a first scanning line, a first terminal of the first controllable switch is connected with a data line in order to receive a data voltage from the data line;
a second controllable switch, wherein the second controllable switch includes a control terminal, a first terminal and a second terminal; the control terminal of the second controllable switch is connected with a second scanning line the first terminal of the second controllable switch is connected with the second terminal of the first controllable switch;
a driving switch, wherein the driving switch includes a control terminal, a first terminal and a second terminal; the control terminal of the driving switch is connected with the second terminal of the second controllable switch, the first terminal of the driving switch is connected with a first voltage terminal in order to receive a first voltage from the first voltage terminal;
a third controllable switch, wherein the third controllable switch includes a control terminal, a first terminal and a second terminal; the control terminal of the third controllable switch is connected with a third scanning line; the first terminal of the third controllable switch is connected with the second terminal of the first controllable switch and the first terminal of the second controllable switch, the second terminal of the third controllable switch is connected with the first terminal of the driving switch;
a storage capacitor, wherein the storage capacitor includes a first terminal and a second terminal; the first terminal of the storage capacitor is connected with the second terminal of the first controllable switch, and the second terminal of the storage capacitor is connected with the second terminal of the driving switch;
an organic light emitting diode, wherein the organic light emitting diode includes an anode and a cathode; the anode of the organic light emitting diode is connected with the second terminal of the driving switch, and the cathode of the organic light emitting diode is connected with a ground; and
a fourth controllable switch, wherein the fourth controllable switch includes a control terminal, a first terminal and a second terminal; the control terminal of the fourth controllable switch is connected with a fourth scanning line, the first terminal of the fourth controllable switch is connected with a second voltage terminal in order to receive a second voltage from the second voltage terminal, and the second terminal of the fourth controllable switch is connected with the second terminal of the driving switch.

2. The pixel compensation circuit according to claim 1, wherein, the driving switch, the first controllable switch to the fourth controllable switch are all NMOS thin-film transistors, PMOS thin-film transistors or a combination of NMOS thin-film transistors and PMOS thin-film transistors; the control terminal, the first terminal and the second terminal of each of the driving switch, the first controllable switch to the fourth controllable switch are respectively corresponding to a gate electrode, a drain electrode and a source electrode of the thin-film transistor.

3. A pixel compensation method, comprising:
in a reset stage, a driving switch and a fourth controllable switch are turned on, a first to a third controllable switches are turned off, a voltage Vb at a second terminal of the driving switch is equal to a second voltage VL outputted from a second voltage terminal; because of a coupling function of a storage capacitor, a voltage Va at a first terminal of the storage capacitor is decreased so as to remove an affection of a data of a previous frame;
in a threshold voltage obtaining stage, the driving switch, the second controllable switch and the third controllable switch are both turned on, the first controllable switch and the fourth controllable switch are both turned off, the storage capacitor is charged; the voltage Vb at the second terminal of the driving switch is equal to a difference value between a first voltage VDD outputted from a first voltage terminal and a threshold voltage Vth of the driving switch, the voltage Va of the first terminal of the storage capacitor is equal to the first voltage VDD;
in a data writing stage, the driving switch and the first controllable switch are both turned on, the second to the fourth switches are turned off, and the storage capacitor is charged; the voltage Va at the first terminal of the storage capacitor is equal to a data voltage Vdata outputted from a data line; the voltage Vb at the second terminal of the driving switch, Vb=VDD−Vth+ΔV, wherein, VDD is the first voltage, Vth is the threshold voltage of the driving switch, ΔV is a voltage increment at the second terminal of the driving switch; and
in a driving emitting stage, the driving switch and the second controllable switch are both turned on, the first controllable switch, the third controllable switch and the fourth controllable switch are all turned off; the storage capacitor is discharged, a voltage difference Vgs between the control terminal and the second terminal of the driving switch is equal to a voltage difference between two terminals of the storage capacitor, that is, Vgs=Vdata−VDD+Vth−ΔV, a current I flowing through the organic light emitting diode is that I=K*(Vgs−Vth)²=K*(Vdata−VDD−ΔV)², wherein K is a coefficient.

4. The pixel compensation method according to claim 3, wherein, the driving switch, the first controllable switch to the fourth controllable switch are all NMOS thin-film transistors, PMOS thin-film transistors or a combination of NMOS thin-film transistors and PMOS thin-film transistors; the control terminal, the first terminal and the second terminal of each of the driving switch, the first controllable switch to the fourth controllable switch are respectively corresponding to a gate electrode, a drain electrode and a source electrode of the thin-film transistor.

5. A flat display device, wherein, the flat display device includes a pixel compensation circuit, and the pixel compensation circuit comprises:
a first controllable switch, wherein the first controllable switch includes a control terminal, a first terminal and a second terminal; the control terminal of the first controllable switch is connected with a first scanning line, a first terminal of the first controllable switch is connected with a data line in order to receive a data voltage from the data line;
a second controllable switch, wherein the second controllable switch includes a control terminal, a first terminal and a second terminal; the control terminal of the second controllable switch is connected with a second scanning line the first terminal of the second controllable switch is connected with the second terminal of the first controllable switch;
a driving switch, wherein the driving switch includes a control terminal, a first terminal and a second terminal; the control terminal of the driving switch is connected with the second terminal of the second controllable switch, the first terminal of the driving switch is connected with a first voltage terminal in order to receive a first voltage from the first voltage terminal;
a third controllable switch, wherein the third controllable switch includes a control terminal, a first terminal and a second terminal; the control terminal of the third controllable switch is connected with a third scanning line; the first terminal of the third controllable switch is connected with the second terminal of the first controllable switch and the first terminal of the second controllable switch, the second terminal of the third controllable switch is connected with the first terminal of the driving switch;
a storage capacitor, wherein the storage capacitor includes a first terminal and a second terminal; the first terminal of the storage capacitor is connected with the second terminal of the first controllable switch, and the second terminal of the storage capacitor is connected with the second terminal of the driving switch;
an organic light emitting diode, wherein the organic light emitting diode includes an anode and a cathode; the anode of the organic light emitting diode is connected with the second terminal of the driving switch, and the cathode of the organic light emitting diode is connected with a ground; and
a fourth controllable switch, wherein the fourth controllable switch includes a control terminal, a first terminal and a second terminal; the control terminal of the fourth controllable switch is connected with a fourth scanning line, the first terminal of the fourth controllable switch is connected with a second voltage terminal in order to receive a second voltage from the second voltage terminal, and the second terminal of the fourth controllable switch is connected with the second terminal of the driving switch.

6. The flat display device according to claim 5, wherein, the driving switch, the first controllable switch to the fourth controllable switch are all NMOS thin-film transistors, PMOS thin-film transistors or a combination of NMOS thin-film transistors and PMOS thin-film transistors; the control terminal, the first terminal and the second terminal of each of the driving switch, the first controllable switch to the fourth controllable switch are respectively corresponding to a gate electrode, a drain electrode and a source electrode of the thin-film transistor.

7. The flat display device according to claim 5, wherein the flat display device is an OLED or an LCD.
